(19) United States
(12) Patent Application Publication
(10) Pub. No.: US 2008/0121701 A1
(43) Pub. Date: May 29, 2008

(54) MULTIMEDIA GENERATION SYSTEM AND METHOD FOR BIOMETRIC EMBEDDED DIGITAL MULTIMEDIA DATA

(76) Inventor: Michael Lynn Gabriel, San Mateo, CA (US)

Correspondence Address: THE MAXHAM FIRM, 9330 SCRANTON ROAD, SUITE 350, SAN DIEGO, CA, 92121, US

(21) Appl. No.: 11/532,441

(22) Filed: Sep. 15, 2006

(51) Int. Cl. G06K 5/00

(52) U.S. Cl. 235/382

(57) ABSTRACT

A system and method for receiving a user's biometric data and decoding encoded biometric embedded digital multimedia data into a multimedia signal based on received biometric data in mechanisms. An example includes a dedicated DVD player with a fingerprint scanner. Alternatively, existing DVD players may be retrofitted for the same function. The fingerprint can be encoded at the beginning of each recorded segment, or only at the beginning of the recorded material on the DVD. The system enables a DVD player to work with a television set, once enabled by matching the biometric data encoded on the medium to be viewed.

### TECHNICAL FIELD

This invention relates generally to digital multimedia signal generation, including apparatus, systems, and methods used in digital multimedia signal generation, and more particularly to a multimedia generation system employing encoded biometric data.

### BACKGROUND INFORMATION

Digital multimedia (DMM), including audio, video, pictures, and combinations thereof, may be encoded into a medium for distribution to one or more persons. Common mediums include optically encoded medium (digital video discs (DVD), compact discs (CD), for example), and electronic transmission of DMM to a DMM converter via one or more communication devices. The DMM may be encrypted to prevent unauthorized usage.

### BRIEF DESCRIPTION OF THE DRAWING

The objects, advantages and features of the invention will be more clearly perceived from the following detailed description, when read in conjunction with the accompanying drawing, wherein:

FIG. 1 is a block diagram of digital multimedia (DMM) distribution architecture according to various embodiments;

FIG. 2 is a block diagram of a biometric embedded digital multimedia (BDMM) encoding device according to various embodiments;

FIG. 3 is a block diagram of a BDMM decoding device according to various embodiments;

FIG. 4 is a flow diagram illustrating several methods according to various embodiments;

FIG. 5 is a flow diagram illustrating several methods according to various embodiments; and

FIG. 6 is a block diagram of a DVD system coupled to a TV according to various embodiments of the invention.

### DETAILED DESCRIPTION

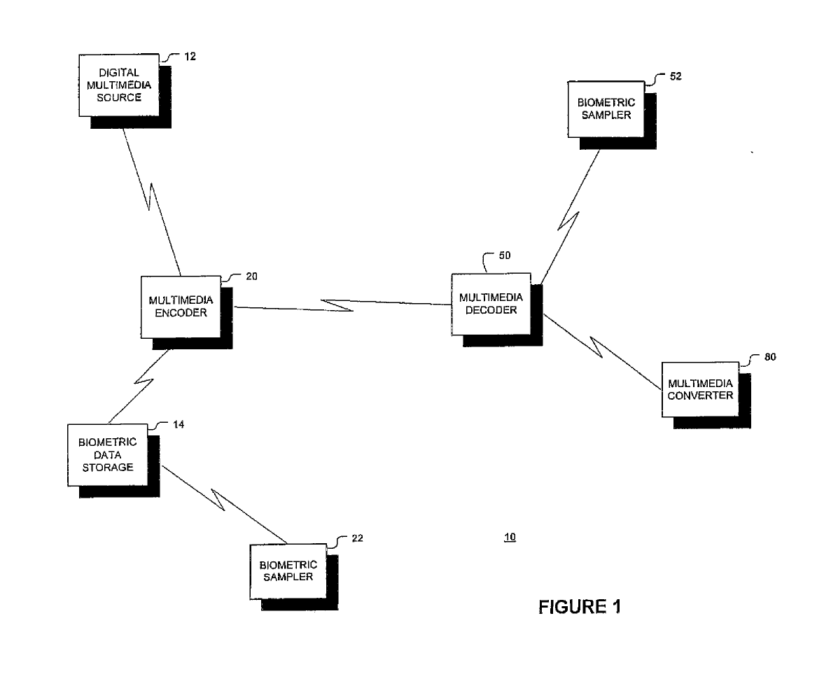

FIG. 1 is a block diagram of DMM communication architecture 10 comprising DMM source 12, a biometric data storage (BDS) 14, a biometric sampler (BS) 22, a second BS 52, a multimedia encoder (MME) 20, a multimedia decoder (MMD) 50, and a multimedia signal converter (MMSC) 80, according to various embodiments. The DMM source 12 may communicate DMM data electronically via a wired or wireless protocol or via a medium, such as a DVD or CD, to MME 20. Embodiments of the MME may encode DMM 12 with user(s)' specific biometric data. In an embodiment the user(s)' specific biometric data may be retrieved from BDS 14 or directly from biometric sampler 22. Biometric sampler 22 may sample user(s)' biometric data and convert it to electronic format. There may be one or more such users, and the singular form will be used here for convenience.

Biometric sampler 22 may transfer the electronic representation of the user's biometric data to BDS 14 or directly to MME 20. BS 22 may communicate the biometric data electronically via a wired or wireless protocol or via a medium, such as a DVD or CD. BDS 14 may be a device capable of storing electronic data by means of a read only memory (ROM), or an optical or magnetic storage medium or device, for example. A user's biometric data may be any relatively unique, electronically measurable biometric characteristic including fingerprint, retinal scan, footprint, voice, or DNA, among others. The biometric data will be generally referred to herein with the word “fingerprint.”

MME 20 may convert user's biometric data (BD) into encrypted biometric data (EBD) via one or more algorithms. Such converting algorithms are available and are not the subject of this invention. The user's biometric data or encrypted format may be appended to the DMM. When the DMM data is provided on a medium, the BD or EBD may be inserted onto the medium (such as adding a session to a DVD) to generate a biometric digital multimedium signal (BDMM). In an embodiment of the invention, the DMM may be algorithmically encoded with the BD or EBD to generate a BDMM. The BDMM may be recorded on a medium for use by the user or communicated via a wire or wireless channel to one or more user designated MMD 50.

According to an embodiment, the biometric data from two or more users may be encoded in the BDMM. In such an embodiment, substantially similar biometric data may be required from one, two, more users, or any permutation thereof, to permit decoding of the BDMM. MMD 50 may receive the BDMM via a wireless or wired channel or via a medium (such as a DVD or CD). Depending on the encoding format (where the MMD may support multiple formats), MMD 50 may require one or more users to provide biometric data via BS 52 The BDMM may include header information indicating the encoding format used in its generation MMD 50 may then use the appropriate algorithm to attempt to decode the BDMM. When the biometric data does not substantially match the BD or EBD of the BDMM, the MMD may generate one or more error message signals. The signals may be converted to a user perceptible format by MMSC 80. The MMSC may be able to generate a user perceptible signal that may be textual, visual, audible, or a combination thereof. MMSC 80 may include one or more speakers and photon generation devices, including a liquid crystal display (LCD), cathode tube (CT), plasma display, television, or projector, among others.

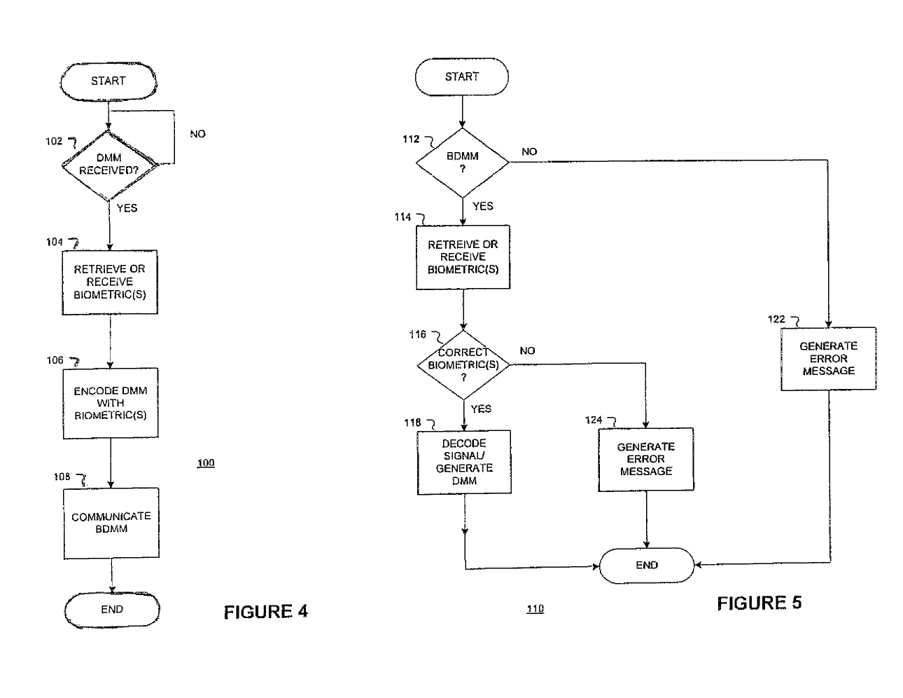

FIG. 4 is a flow diagram of a DMM encoding method 100 according to various embodiments of the invention. The method may, upon receipt of a DMM signal, retrieve or receive BD for one or more users (activities 102, 104). The DMM data may be stored locally or transmitted to an MME upon request of the user. The method may encode a portion or entire DMM via the BD or EBD in an embodiment (activity 106). Method 100 may also encode the BD or EBD on a segment of a medium including the DMM or at least a portion of the DMM.

In an embodiment of the invention, method 100 may then communicate the BDMM (activity 108). The method may broadcast the BDMM to one or more locations designated by the user via a wireless or wired protocol. The method may also communicate the BDMM by generating a computer readable medium including the BDMM. In an embodiment, method 100 may include a header or other information within the BDMM that indicates the algorithms or techniques employed to generate the BDMM.

FIG. 5 is a flow diagram of a BDMM decoding method 110 according to various embodiments of the invention. The method may receive or have DMM signals. In the embodiment shown, if the DMM is not encoded via a known or determinable BDMM format, the method may not decode or process the DMM (activity 112). Method 110 may generate an error message (activity 122) indicating that an improper DMM file has been provided. When the method detects that a properly encoded biometric embedded DMM (BDMM) is present (via medium or communication), method 110 may retrieve or request to receive BD for one or more users (activity 114). The method may then determine whether the proper BD has been received or presented (activity 116). In an embodiment, method 110 may then decode the BDMM using the BD (activity 118). In an embodiment, (not shown) method 110 may decode the BDMM regardless of the BD received. In such an embodiment, when improper BD is provided, the resultant, decoded DMM may be imperceptible when communicated to MMSC 80.

Method 110 may generate an error message (activity 124) indicating that improper BD was provided The method may then reject the BDMM or store some identifying data about the BDMM so that when subsequently presented the BDMM is automatically locked out. The method may enter such a locked state after two or more improper BD validation attempts are made.

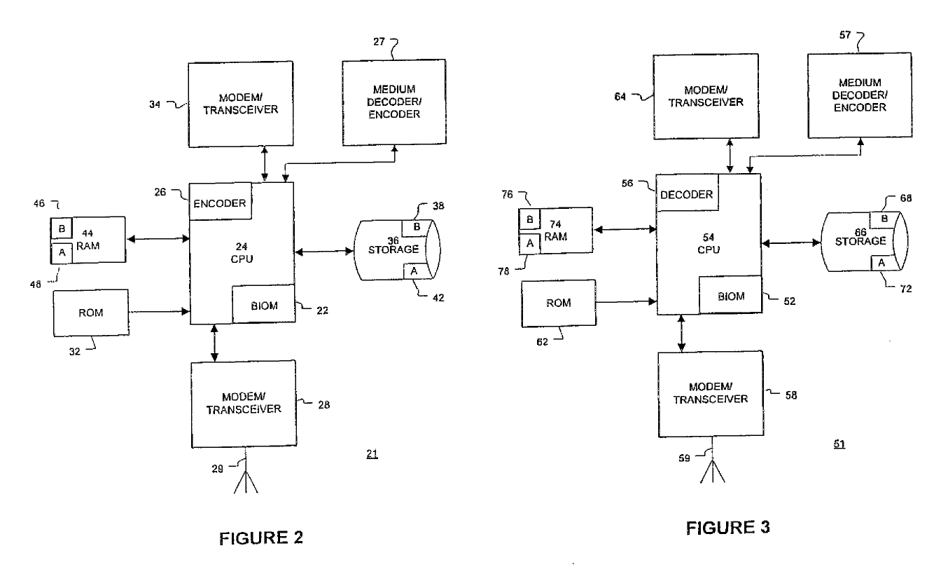

FIG. 2 illustrates a block diagram of a device 21 that may be employed as MME 20 in various embodiments. Device 21 may include CPU 24, RAM 44, ROM 32, storage unit 36, first modem/transceiver 34, second modem/transceiver 28, antenna 29, and medium decoder/encoder 27. CPU 24 may include DMM encoder 26 and BS interface 22. RAM 44 may include BD 46 and algorithm instruction set(s) 48. Storage 36 may include BD 38 and algorithm instruction set(s) 42. DMM encoder 26 and biometric data interface 22 may be separate modules.

DMM encoder 26 may receive DMM data from either transceiver 28, 34, or medium decoder/encoder (MDE) 27. The MDE may be able to read or write media (such as a DVD or CD). BD 46 or 38 may include BD for one or more authorized users associated with the DMM to be encoded. The algorithm instruction set(s) 48 or 42 may include instructions for encoding or encrypting the BD and DMM data in various formats. The encoded biometric embedded DMM (BDMM) may be communicated to an MMD (50 in FIG. 1) via transceiver 34 or 28, or encoded on media via MDE 27.

In an embodiment of the invention, first modem/transceiver 34 may couple, in a well-known manner, device 21 to an Internet connection or via a wired telephone system such as the Plain Old Telephone System (POTS). The second modem/transceiver 28 may couple device 21 to one or more wireless networks. Modem/transceiver 34 may be a wireless modem or other communication device that communicates with MMD 50 in the architecture 10 (FIG. 1). CPU 24, via encoder 26, may direct communication between the first and second modems, 34 and 28, respectively, or to MDE 27. ROM 32 may store program instructions to be executed by the CPU, encoder 26, or BD interface 22. RAM 44 and storage 36 may be used to store temporary program information, wireless protocols, queues, and overhead information, among others.

FIG. 3 illustrates a block diagram of a device 51 that may be employed as MMD 50 in various embodiments. Device 51 may include CPU 54, RAM 74, ROM 62, storage unit 66, first modem/transceiver 64, second modem/transceiver 58, antenna 59, and medium decoder/encoder 57. The CPU may include DMM decoder 56 and BS interface 52. The RAM may include BD 76 and algorithm instruction set(s) 78. Storage 66 may include BD 68 and algorithm instruction set(s) 72. In this embodiment DMM encoder 56 and biometric data interface 52 may be separate modules.

DMM decoder 56 may receive DMM data from either transceiver 58, 64 and medium decoder/encoder (MDE) 57. The MDE may be able to read or write media (such as a DVD or CD). BD 76 or 68 may include BD for one or more authorized users associated with the DMM to be decoded. Algorithm instruction set(s) 78 or 72 may include instructions for decoding or decrypting the BDMM in various formats. The decoded DMM may be communicated to MMSC 80 via transceiver 64 or 58.

In an embodiment of the invention, first modem/transceiver 64 may couple, in a well-known manner, device 51 to an Internet connection or via a wired telephone system such as the POTS. Second modem/transceiver 58 may couple device 51 to one or more wireless networks. Modem/transceiver 64 may be a wireless modem or other communication device that communicates with MME 20 in the architecture 10 (FIG. 1). CPU 54, via decoder 56, may direct communication between the first and second modems, 64 and 58, respectively, or to the MMSC 80. ROM 62 may store program instructions to be executed by CPU 54, decoder 56, or BD interface 52. RAM 74 and storage 66 may be used to store temporary program information, wireless protocols, queues, and overhead information, among others.

Any of the components previously described can be implemented in a number of ways, including embodiments in software. Thus, MME 20, BDS 14, BS 22, MMD 50, BS 52, MMSC 80, CPU 24, encoder 26, biometric interface 22, RAM 44, ROM 32, storage 36, BD 46, 38, algorithm instruction set(s) 42, 48, CPU 54, decoder 56, biometric interface 52, RAM 74, ROM 62, storage 66, BD 76, 68, and algorithm instruction set(s) 72, 78, may all be characterized as “modules” herein.

In a particular embodiment of the invention, modem-transceiver 58 (FIG. 3) may be able to communicate with a remote control where a user may send signals to control the operation of device 51 such as pausing, reversing, and forwarding the decoding of the BDMM. The remote control may include biometric sampler 52 such as a fingerprint sampler. The remote control may be part of a wireless personal data assistant (PDA) or cellular phone. Medium decoder/encoder 57 may be a DVD reader-writer where the DVD reader-writer may be coupled to CPU 54 via various computer interfaces including Integrated Drive Electronics (IDE), Advanced Technology Attachment (ATA), Small Computer System Interface (SCSI), Universal Serial Bus (USB), system bus, or other CPU interface

In a particular embodiment device 51 may be a DVD player where the DVD player includes a DVD reader functioning as medium decoder/encoder 57. The DVD player may have a modem-transceiver 58 that is able to communicate with a wireless device (such as a wireless remote, PDA, or cellular phone.) The DVD player may include storage 66 which may store the user's biometric data 68. Storage 66 may also use an algorithm 72 to decode BDMM data. A DVD player may be modified to support the BDMM by modifying its instruction set to include algorithm 72 and user's biometric data 68.

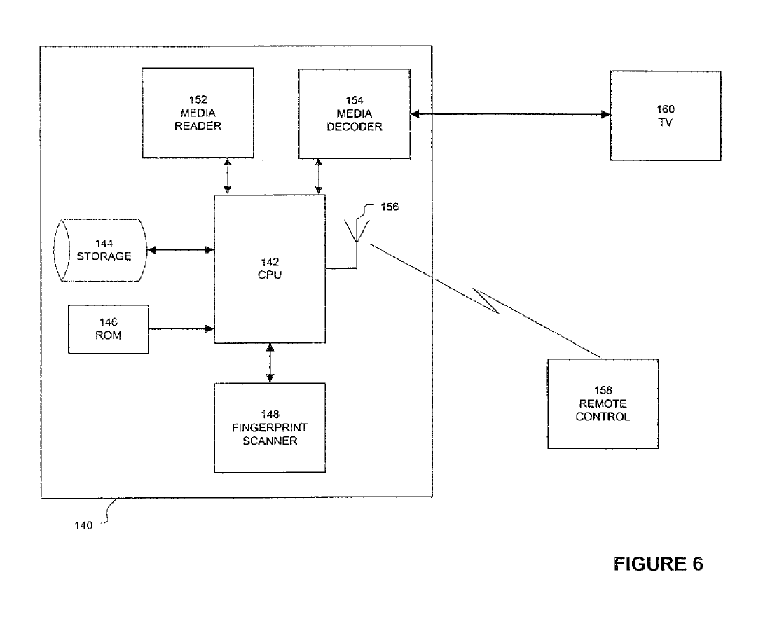

A specific example of a system according to various embodiments of the invention is shown in FIG. 6, which is a block diagram of DVD system 140 coupled to TV 160. As shown, DVD system 140 includes CPU 142, storage unit 144, ROM 146, fingerprint scanner 148, media reader 152, media decoder 154, antenna 156, and wireless remote control 158. Media reader 152 may be a DVD, CD, or other media reader where the media may include BDMM data. A user, via fingerprint scanner 148, would provide biometric data to CPU 142. ROM 146 stores CPU instruction sets. CPU 142 receives the biometric data and retrieves BDMM data from media reader 152. CPU 142 stores the biometric data or retrieved BDMM data in storage unit 144.

CPU 142 employs the biometric data to decrypt the BDMM data and forward the decrypted DMM data to media decoder 154. The media decoder converts the DMM data to a format usable by TV 160. The format may include National Television System Committee (NTSC), Phase Alternation Line (PAL), S-VIDEO, Digital Visual Interface (DVI), High Definition Multimedia Interface (HDMI), or component video, among others. In an embodiment, remote control 158 may control the function of the CPU via antenna 156. Remote control 158 may include a fingerprint scanner or other biometric reader where the remote control may forward the scanned biometric data to CPU 142, and can be a PDA, cellular phone, or equivalent.

The modules may include hardware circuitry, single or multiprocessor circuits, memory circuits, software program modules and objects, firmware, and combinations thereof as desired by the architect of architecture 10 and as appropriate for particular implementations of various embodiments They are not intended to serve as a complete description of all the elements and features of apparatus and systems that might make use of the structures described herein.

Applications that may include the novel apparatus and systems of various embodiments of the invention include electronic circuitry used in high-speed computers, communication and signal processing circuitry, modems, single or multi-processor modules, single or multiple embedded processors, data switches, and application-specific modules, including multilayer and multi-chip modules, among others. Such apparatus and systems may farther be included as sub-components within a variety of electronic systems, such as televisions, cellular telephones, personal computers (for example, laptop computers, desktop computers, handheld computers, tablet computers, among others), workstations, radios, video players, audio players (for example, MP3 players), vehicles, medical devices (for example, heart monitor, blood pressure monitor, and the like) and others. Some embodiments may include a number of methods.

It may be possible to execute the activities described herein in an order other than the order described. And, various activities described with respect to the methods identified herein can be executed in repetitive, serial, or parallel fashion.

A software program may be launched from a computer-readable medium in a computer-based system to execute functions defined in the software program. Various programming languages may be employed to create software programs designed to implement and perform the methods disclosed herein. The programs may be structured in an object-orientated format using an object-oriented language such as Java or C++. Alternatively, the programs may be structured in a procedure-orientated format using a procedural language, such as assembly or C. The software components may communicate using a number of mechanisms well known to those skilled in the art, such as application program interfaces or inter-process communication techniques, including remote procedure calls. The teachings of various embodiments are not limited to any particular programming language or environment.

The accompanying drawing figures that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This description, therefore, is not to be taken in a limiting sense, and the scope of various embodiments is defined only by the appended claims, along with the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In the foregoing description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the description, with each claim standing on its own as a separate embodiment

What is claimed is:

1. A encoded biometric embedded digital multimedia (BDMM) decoding module comprising:
a biometric data interface to receive biometric data for a user; and
a decoder to decode the BDMM based on user biometric data to a multimedia signal and communicate the multimedia signal to a multimedia signal converter.

2. The BDMM decoding module of claim 1, and further comprising a media decoder, wherein the BDMM to be decoded is stored on media readable by the media decoder.

3. The BDMM decoding module of claim 2, wherein the user biometric data is fingerprint data.

4. The BDMM decoding module of claim 1, wherein the BDMM is encoded using one of a plurality of encoding formats, wherein the decoder detects the BDMM encoding format to decode the BDMM based on the detected encoding format.

5. The BDMM decoding module of claim 2, wherein the media is optically readable media.

6. The BDMM decoding module of claim 2, wherein the BDMM represents encoded video data.

7. The BDMM decoding module of claim 2, wherein the biometric data interface includes a fingerprint scanner.

8. The BDMM decoding module of claim 7, wherein the multimedia signal converter includes one of a liquid crystal display (LCD), a cathode tub (CT), a plasma display, a television, and a projector.

9. The BDMM decoding module of claim 2, wherein the decoder is a DVD player.

10. The BDMM decoding module of claim 9, further including a remote control for controlling the operation of the DVD player.

11. A biometric encoded multimedia system comprising:
a multimedia signal converter to convert multimedia signals into a user perceptible format;
an encoded biometric embedded digital multimedia (BDMM) decoding module, comprising:
a biometric data interface to receive biometric data for a user; and
a decoder to decode the BDMM based on user biometric data to a multimedia signal and communicate the multimedia signal to the multimedia signal converter.

12. The system of claim 11, the BDMM decoding module further comprising a media decoder, wherein the BDMM to be decoded is stored on media readable by the media decoder.

13. The system of claim 12, wherein the user biometric data is fingerprint data.

14. The system of claim 11, wherein the multimedia signal converter is physically separate from the BDMM decoding module.

15. The system of claim 14, wherein the multimedia signal converter communicates the multimedia signal to the BDMM decoding module via at least one conductive cable.

16. The system of claim 11, wherein the BDMM is encoded using one of a plurality of encoding formats, wherein the decoder detects the BDMM encoding format to decode the BDMM based on the detected encoding format.

17. The system of claim 12, wherein the media is optically readable media.

18. The system of claim 14, wherein the BDMM represents encoded video data.

19. The system of claim 12, wherein the biometric data interface includes a fingerprint scanner.

20. The BDMM decoding module of claim 19, wherein the multimedia signal converter includes one of a liquid crystal display (LCD), a cathode tub (CT), a plasma display, a television, and a projector.

21. The BDMM decoding module of claim 19, wherein the decoder is a DVD player.

22. The BDMM decoding module of claim 21, further including a remote control for controlling the operation of the DVD player.

23. A method for generating biometric embedded digital multimedia data, the method comprising:
at a digital multimedia (DMM) encoding module:
receiving DMM data;
retrieving or receiving biometric data for a user to be associated with received DMM data; and
encoding received DMM data based on received biometric data; and
at an encoded biometric embedded digital multimedia (BDMM) decoding module:
receiving biometric data for a user; and
decoding the BDMM based on user biometric data to a multimedia signal and communicate the multimedia signal to a multimedia signal converter.

24. The method of claim 23, wherein the user biometric data is fingerprint data.

25. The method of claim 24, wherein at the DMM encoding module, encoding the DMM using one of a plurality of encoding formats and at the BDMM decoding module detecting the BDMM encoding format and decoding the BDMM based on the detected encoding format.

26. The method of claim 23, wherein the DMM represents video data.

27. An article including a machine-accessible medium having associated information, wherein the information, when accessed, results in a machine performing:
at an encoded biometric digital multimedia (BDMM) decoding module:
receiving biometric data for a user; and
decoding the BDMM based on user biometric data to a multimedia signal and communicate the multimedia signal to a multimedia signal converter.

28. The article of claim 27, wherein the user biometric data is fingerprint data.

29. The article of claim 27, wherein the BDMM represents encoded video data.
